(19) United States
(12) Patent Application Publication
(10) Pub. No.: US 2009/0218526 A1
(43) Pub. Date: Sep. 3, 2009

(54) SCATTERING CENTRE DETECTOR ASSEMBLY AND METHOD

(75) Inventors: Jonathan Robert Shaw, Glossop (GB); Nigel Edward Harris, High Peak (GB); Christopher James Lloyd, Hollingworth (GB); Leonard Frederick George Williams, Preston Bissett (GB)

Correspondence Address: ADAMS INTELLECTUAL PROPERTY LAW, P.A., Suite 2350 Charlotte Plaza, 201 South College Street, CHARLOTTE, NC, 28244, US

(73) Assignee: ETR-UNIDATA LIMITED, South Yorkshire (GB)

(21) Appl. No.: 12/067,578

(22) PCT Filed: Sep. 15, 2006
(86) PCT No.: PCT/GB06/03428

§ 371 Date: Oct. 14, 2008

(30) Foreign Application Priority Data
Sep. 22, 2005 (GB) 0519323.0

(51) Int. Cl. G01N 21/49

(52) U.S. Cl. 250/574

(57) ABSTRACT

An assembly which comprises (a) a duct (22) for transmission of fluids, said duct having longitudinal axis, (b) at least one emitter (301) capable of exciting a beam of radiation (21) in the form of a cone having root angles βₑₓ and β_{ey}, which may be the same or different, into a cross section area of a duct to be analysed in a direction downstream of fluid flow in the duct at an angle λₑ from the plane perpendicular to the longitudinal axis of the duct, the angle λₑ being between 5° to 45°, (c) a detector (23, 304) sensitive to radiation radiated by scattering centres in the fluid over at least 1% of the cross sectional area of the duct, the direction of the central axis of the emitter cone being at an angle α to the direction of the central axis of the detector cone, the detector cone having root angles β_{dx} and β_{dy}, which may be the same or different and the detector cone having angle λ_{d} perpendicular to the longitudinal axis of the duct, the direction of the detector being downstream of fluid flow in the duct, the angle α being in the range 0° to 180° and angle λ_{d} being between 5° to 45°, the detector collecting scattered radiation and the detector being coupled to (d) a collator (310) for collecting data from the detector.

This invention relates to scattering centre detection and in particular to assembly and methods for detecting scattering centres in fluids in a duct.

Scattering centres as defined in the present invention include any material that can scatter radiation within a duct. Whilst scattering centres may in particular be particulate, as hereinafter described, they may include, for example, droplets of liquid or bubbles of gaseous material. By the term “particulate” in this specification is meant one or more scattering centres as animal, vegetable or mineral material in particle form. In particular, the term includes minute particulate material found in an atmosphere and generated within industrial processes and engines and found in associated ducts. Examples of droplets include, for example, water, oil and other liquid substances which have not been fully mixed or dissolved into the fluid in which they are present. Fluid as defined in the present invention includes any material which can flow in a duct. Such fluids include, for example, liquids and gases, in particular exhaust gases and which do not react significantly chemically with material used in the duct.

Therefore the assembly and method of the invention are appropriate, for example, for the detection in a duct of
Particulate in waste gases
Gas bubbles in water
Particulate in oil
Water droplets in air

A particular use of the invention is in the detection of particulate in gas. Presence of particulate is in many situations at least a nuisance and at worst catastrophic or illegal. Particulate can carry impurities into locations where its presence is undesirable. Such locations include industrial plant and the environment including air quality monitoring. Thus in the manufacture for example of electronic components the presence of particulate can lead to impurities being included inadvertently in the component, for example, a chip, so rendering the component faulty.

In electricity generating stations, for example, particulate in the inlets to turbines must be kept to a minimum in order to reduce particulate build up on the turbine blades; such build up has to be removed, generally by water spraying, or, if not carried out, leads to a reduction in turbine performance and ultimately blade disintegration with obvious destructive results. In either event, generating time is reduced. Excessive water spraying may lead to reduced efficiency of the operation; water vapour leads to corrosion and may resulting a bias of instruments analysing duct emissions.

Particulate free conditions in the examples given above should exist in the inlet of gas, often air, into the relevant area. However particulate should not be fed through the outlet of an area. For example, exhaust from power stations, industrial processing including chemical plant processes, should not emit particulate into the atmosphere. Similar concerns are relevant in the context emissions from stacks of incinerators including crematoria. Such a practice is environmentally unacceptable and emissions must be kept within approved maximum or legal limits.

Particulate and other unwanted scattering centres entering or leaving an area are generally reduced by the use of a range of abatement systems, often located in a duct through which fluid is supplied to an area or removed from an area. Such abatement systems include, for example, filters, combination of filters, electrostatic precipitators, wet arresters. If the abatement system has been fitted incorrectly or erroneously or in time the abatement system degrades, the efficiency of the abatement system in reducing particulate passing through the abatement system is reduced. It is common practice to replace an abatement system after a given period which is determined by experience of acceptable abatement system performance. It is also found however that an abatement system may fail catastrophically before that period has been exhausted and allow unacceptable passage of particulate through the filter system. This is a particular problem where, for example, the gas flow is very high or where the abatement system comprises a set of filters and one filter in the set should prematurely fail.

Analysis of total filter failure by conventional means is limited in that damage has already occurred. At the onset of failure the particles passing through the filter may only be just larger than that supposed to be excluded and conventional means may not be able to discern that failure is imminent.

Presently available particulate detectors for use in large industrial ducts, such as emission stacks from electricity generating stations, have hitherto suffered from a number of disadvantages. These include the use of a narrow beam of radiation, typically in the visible, so that only a small cross section area of the duct is analysed by turbidity which measures total loss of radiation absorption (e.g. water vapour, gasses) and not only scattering by particulate is detected; here zero measurement of particulate is the maximum signal detected.

It is an object of the assembly and method of the present invention to overcome such disadvantages. There is therefore a requirement for an assembly and a method for detecting of scattering centres in large ducts and at a wide temperature range. Examples of such ranges are temperature from −60° C. to +100° C., ambient up to 500° C. duct surface temperature, up to 700° C. thermal shock tolerance, up to 1500° C. internal duct temperature, minimal vibration insensitivity, maximum mechanical rigidity where the duct emission would foul or damage any optical component and where pressure in the duct is above atmospheric.

In the present invention, an emitter and a detector, both as hereinafter defined, have a volume of emission and detection respectively in the shape of a cone. The cone herein is a solid figure, having an apex, bounded by a plane, the plane being, for example, a circle, square, rectangle, pentagon, hexagon, but preferably an ellipse. In the assembly of the present invention, the apex of the cone is located at the emitter or detector as appropriate and the volume is intercepted by the inner surface of the wall of the duct. Each cone has two root angles mutually at right angles; in the emitter these are βₑₓ and β_{ey}; in the detector these are β_{dx} and β_{dy}. A root angle is the angle between the central longitudinal axis of the cone and the side-wall of the cone. The root angle x is in the direction of the longitudinal axis of the duct and the y root angle is across the longitudinal axis of the duct, i.e. across the cross-section off the duct. These root angles define the plane of the cone; if, for example, βₑₓ=β_{ey}, the emitter has a circular cone; preferably βₑₓ≠β_{ey} and the cone has a elliptical plane. Preferably β_{ey}>βₑₓ and βₑₓ is small. typically β_{dx}=β_{dy}

According to the present invention, an assembly is provided which comprises
(a) a duct for transmission of fluids, said duct having longitudinal axis,
(b) at least one emitter capable of exciting a beam of radiation in the form of a cone having root angles βₑₓ and β_{ey}, which may be the same or different, into a cross section area of a duct to be analysed in a direction downstream of fluid flow in the duct at an angle λₑ from a plane perpendicular to the longitudinal axis of the duct, the angle λₑ being between 5° to 45°,
(c) a detector sensitive to radiation radiated by scattering centres in the fluid over at least 1% of the cross sectional area of the duct, the direction of the central axis of the emitter cone being at an angle α to the direction of the central axis of the detector cone, the detector cone having root angles β_{dx} and β_{dy}, which may be the same or different and the detector cone having angle λ_{d} perpendicular to the longitudinal axis of the duct, the direction of the detector being downstream of fluid flow in the duct, the angle α being in the range 0° to 180° and angle λ_{d} being between 5° to 45°, the detector collecting scattered radiation and the detector being coupled to
(d) a collator for collecting data from the detector.

Suitably, the detector is ac coupled to the collator.

Suitably, the collator is configured to correct for any errors or variations in the data caused by transient factors.

Suitably, the assembly further comprises:
(e) a logger for processing the signal from the collator and comparing its level to known contamination level and providing information on the detected radiation.

The apparatus and method of the present invention rely on the detection of scatter from scattering centre of radiation to which they are subjected. By the term “scatter” is meant to include sparkle, glitter or glisten of radiation from a scattering centre. The scatter may be in any direction as radiation is interfered with or reflected from the scattering centre; at least some of the scatter will be in the direction of the detector.

The apparatus of the invention will be associated with an inlet or outlet duct which directs fluid into or out from a location. The duct may be any closed or semi-enclosed space through which fluid may flow, such as for example, a pipe, chimney, tunnel, shaft, aircraft engines. The duct may be constructed from any suitable material known in the art. Examples of ducting include metal, typically, steel which may be coated or uncoated (e.g. galvanised), stainless steel, aluminium; plastics materials, for example rigid or flexible polyvinyl chloride, polypropylene, glass, polystyrene, low or high density polyethylene, ABS and the like; and the ducting may be in concertina form. The ducting may be transparent or opaque. The ducting may be of any convenient or suitable cross section such as, for example, rectangular (e.g. square), circular, oval, and have any cross sectional size provided that the cross section can accommodate the emitter and detector. Cross sectional area of a duct is relatively unimportant and the apparatus and method of the invention can be used with any size or shape of duct, although emitter output and detector sensitivity should be optimised to duct parameters. The invention is of particular importance in the detection and monitoring of particulate in industrial exhaust situations, often referred to as “stacks”. Stacks generally exhaust waste gases to the environment and hence presence of particulate and other impurities must be strictly controlled, often within legal limits. Stacks operate in a wide range of internal temperatures, typically up to 1500° C. Such high temperatures are found, for example, in the exhaust fumes from electricity generating stations and crematoria.

The emitter and the detector are attached as units to a duct with radiation access to the duct. Apertures are provided in a side wall of the duct with attachments apparatus for cooperation with mating attachments on each unit so that the emitter to has uninterrupted access to scattering centres and fluid in the duct. Preferred mating attachments are flanges provided on the duct and each unit. The detector should have a wide acceptance angle, which may be limited by the dimensions of the housing in which the detector is located. If the emitter and detector are mounted at right angles to the longitudinal axis of the duct, a number of distortions may be experienced so leading to inaccurate determination of levels of, for example, particulate and other scattering centres. For example, in such a situation, particulate could build up at the junction of the detector and duct aperture, vortices will be set up at that junction. In accordance with the present invention, the direction of the centre of the emitter beam is at an angle α to the line of the detector, and the emitter and detector lines are at elevation angles λₑ and λ_{d} respectively perpendicular to the longitudinal axis of the duct, the direction of the detector being downstream of gas flow in the duct. The angle α is in the range 0° to 180°, preferably 60° to 85° and angles λₑ and λ_{d} are between 5° to 45°, preferably 10° to 20°, and may be the same or different.

Whilst the emitter may be any source of radiation from ultra-violet to deep infra-red. Visible or near visible radiation is preferred albeit from any source such as, for example, halogen lamp, laser, filament light; however a light emitting diode is preferred because of better associated reduced degradation by thermal and physical shock, narrow emission spectrum and high efficiency of conversion of electrical power to light.

A preferred radiation source for the emitter is a light emitting diode having a wavelength in the range 610 to 640 nm and having full half width maximum bandwidth of 40 nm. Preferably the emitter is protected by a heat mirror. Preferably the detector is filtered to eliminate detection of radiation outside the bandwidth of the emitter. By way of example, if an emitter has an emission profile between 610 and 640 nm, one or more filters may be used to eliminate detection below 600 nm and above 650 nm. Preferably the detector is protected by a heat mirror. Preferably the heat mirror substrate is absorptive of wavelengths greater than those that may be reflected by its coating thus blocking very long infra red by absorption. Where a duct may contain multiple emitter heads or other optical instruments it is preferred also to filter the emitter to stop unwanted noise emission

Where emitters of radiation in other frequency range are used, the apparatus should be provided with appropriate similar filters. Power output of the emitter is determined by the diameter or cross sectional area of the duct but should be at least 10 mW optical; for example for a tubular duct having a 1 m diameter, a light emitting diode having electrical rating of 1 W optical output of 150 to 300 mW would be suitable for analysing stone dust at concentrations of the order of 60 mg/m³.

The output from the emitter is pulsed. Whilst any pulse rate in the range of 0.1 to 10⁶ pulses per second may be used, a preferred pulse rate is once or twice mains electrical supply frequency. Use of that frequency eliminates transient errors caused by any fluctuation in pulse frequency. Output efficiency from a light emitting diode increases with current density. However, increase in current density increases heat production in the diode so reducing its life. This may be overcome by reducing the width of each pulse and driving the diode at a higher current over that short pulse. Hence the output from the diode is increased without reduction in diode life which would have been the effect of driving the diode at that higher current over the whole of the pulse. The period of the narrow pulse may be varied by may be of the order of 1 to 100 μs.

It may be that output from an emitter is not stable in respect of output intensity. This may be rectified by measuring output intensity and compensating but may also be effected by electronic feedback loop (negative feedback). However negative feedback only provides limited accuracy of compensation and operates only over a given range. Therefore a preferred approach is to normalise emitter intensity with detector sensitivity to take account of variations input intensity caused by, for example, variation in temperature between emitter and detector temperatures. However normalisation ignores second and third order errors such as detector linearity and thus it is preferred that both normalisation and negative feedback are incorporated.

The emitter, its related electronics and any filters are preferably located in a housing, and the housing mounted on the side wall of the duct, preferably secured by the use of cooperating flanges on the duct wall and the housing. Gas, which should be dry and clean, preferably air, are introduced into the housing so that the contents of the housing may be maintained within an acceptable operating temperature range, and kept essentially free of particulate and other materials that may interfere with detector output. The gas would typically be air but other gases may be used and, preferably, the gas would be similar to that within the duct. Such gas may be arranged to be fed through the assembly and into the duct. In a preferred embodiment, the gas is fed around the emitter and related electronics, out of the housing and then across any filters via a one-way valve so as to reduce the risk of heated gas being fed back to the emitter and its related electronics. The radiation emitted from the emitter is preferably fanned, i.e. angle βₑₓ is small, typically between 2.5° and 7.5° and β_{ey} is between 7.5° and 22.5°, typically between 10° and 15°.

Therefore in accordance with a further aspect of the present invention, an emitter unit for the assembly is provided which comprises a housing for attaching the unit to a duct and for accommodating emitter components, said components comprising an emitter and electronic circuit boards for stimulating signals to be emitted from the emitter, and inlets and outlets for gas for circulation around the emitter components.

The detector is selected to match the radiation of the emitter. A typical detector is a semiconductor device. Large area semiconductors devices with efficiency rated up to 14% are economically produced for solar cells and may be used in the device. However the invention is not limited to a detector type and many forms of detectors, such as, for example, avalanche photodiodes and pin detectors or high voltage phosphor based devices such as, for example, photomultiplier tubes or image intensifiers could be used. High efficiency detectors are preferred and hence crystalline semiconductor devices are preferred over amorphous devices. The detector unit is similar to the emitter unit except that detector components are included rather than emitter components. The detector is preferably a large area solar cell. A suitable detector for a 1 m diameter duct comprises two rectangular solar cells each having dimensions 50 mm×25 mm electrically connected to make a single cell 50×50 mm.

The emitter and detector should be so oriented as to enable at least 1% of the cross sectional area of the duct to be analysed. The area to be detected is desirably as large as possible; however if the detector is close to the duct which would enable a wide area to be detected, heat from the duct would adversely affect performance of the detector ands its electronics, whilst locating the detector distant from the duct would reduce the area detected and so reduce detector sensitivity. The area detected is defined by 2β_{dy} which should be between 20° and 80° typically between 25° and 40°. Preferably it covers more than 10%, and most preferably more than 30%, of yhe duct cross sectional area because the detector detects radiation over an area of the duct not directly in the light beam and preferably to an area where little or not emitted radiation is reflected back to the detector from walls of the duct. These practical limits mean that the area analysed is not likely to exceed 50% of the cross sectional area of the duct.

Therefore in a further aspect of the present invention a detector unit for the assembly is provided which comprises a housing for attaching the unit to a duct and for accommodating detector components, said components comprising a detector and electronic circuit boards for receiving signals from the detector, and inlets and outlets for gas for circulation around the detector components.

The collator detects scattered light from any scattering centre and compensates that signal having regard to other inputs that it receives. Such inputs from transient factors include, for example, electronic noise generated in the assembly, temperature fluctuations in the emitter or detector, thermal changes in the process associated with the duct and mains electricity supply variations. The collator contains a microprocessor programmed to account for any such compensations required. The collator may also trigger an alarm function in the event of equipment or input variation above or below a given level. The collator may also carry out mathematical functions on the data such as averaging. The collator is preferably located within the detector unit; one reason is that cabling from a detector to a logger may be long so leading to loss of signal power and definition, and high cost of cabling. This is particularly the situation where the detector is located near the top of a tall duct and the logger is located in a control cabin some distance from the duct.

Output from the collator is sent to a logger. The logger may be located with the collator or more often connected at a remote position from the collator by for example a wireless link or a cable. The logger processes the signal from the collator and compares its level to known scattering centre level. Scattering centre, such as particulate, is conveniently measured in terms of mg per m³. The logger may store the so determined level of contamination and may average that level over a given period, for example, 2 s to 1000 s. If the level of particulate exceeds a given level, then the logger may activate an alarm. The logger and any alarm functions may store any such related data on a removable storage media, such as for example, a smart card.

According to a further aspect of the present invention, a method is provided for monitoring impurity in fluid within a duct having a longitudinal axis which comprises
(a) exciting a beam of radiation from an emitter in the form of a cone having root angles βₑₓ and β_{ey}, which may be the same or different, into a cross section area of a duct to be analysed in a direction downstream of fluid flow in the duct at an angle λₑ perpendicular to the longitudinal axis of the duct, the angle λₑ being between 5° and 45°,
(b) detecting radiation radiated by any scattering centre in the fluid over at least 1% of the cross sectional area of the duct, the direction of the central axis of the emitter cone being at an angle α to the direction of the central axis of the detector cone, the detector having root angles β_{dx} and β_{dy}, which may be the same or different, having an acceptance angle in the range 10° to 40° and the detector cone having an angle λ_{d} from the plane perpendicular to the longitudinal axis of the duct, the direction of the detector being downstream of fluid flow in the duct, the angle α being in the range 0° to 180° and angle λ_{d} being between 5° to 45°,
(c) orientating the detector in a position on the duct that is not directly in the path of the excitation beam,
(d) collating data from the detector and correcting for any errors or variations in that data caused by transient factors, and
(e) logging the signal from the collator and comparing its level to known contamination level and providing information on the detected radiation
   whereby interaction of the light is detected and at least one parameter of any scattering centre in the fluid is measured.

The invention is illustrated with reference to the accompanying figures in which

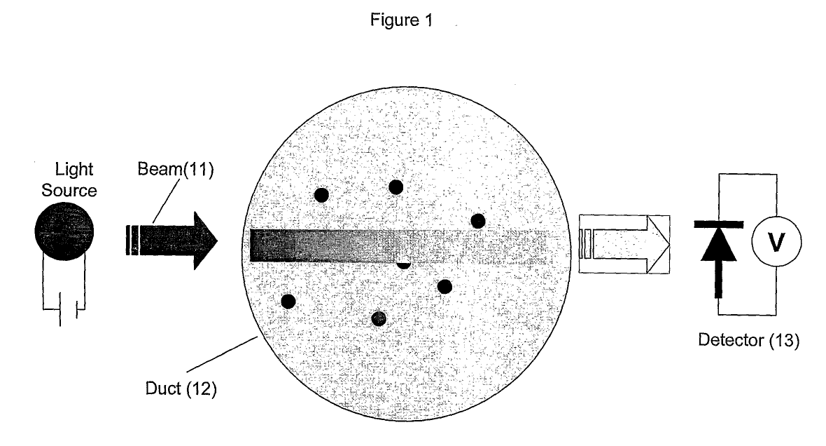

FIG. 1 shows diagrammatically a conventional detection system,

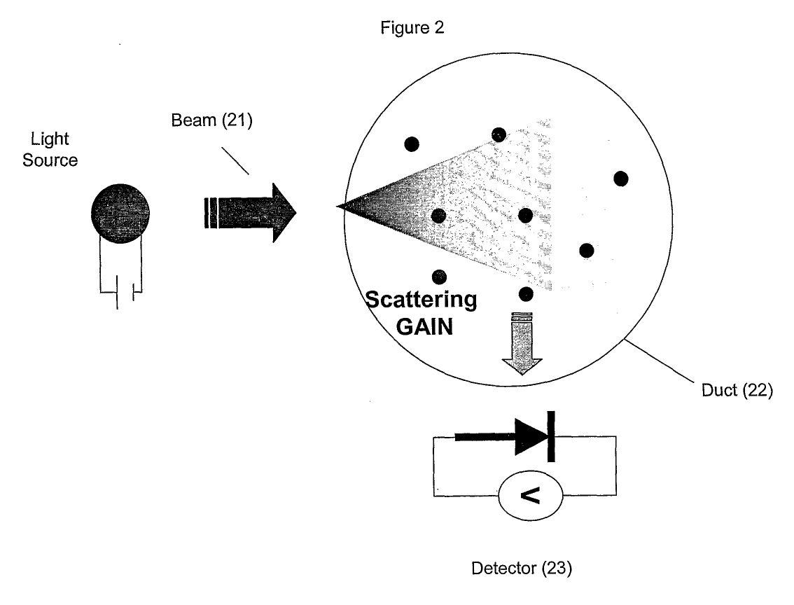

FIG. 2 shows diagrammatically a detection system according to the present invention,

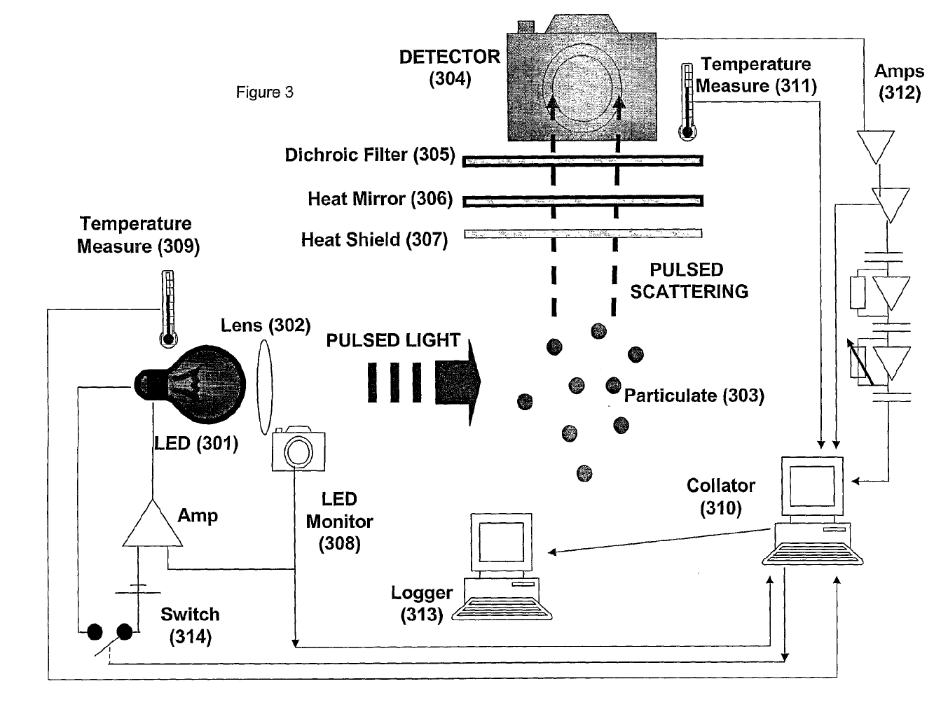

FIG. 3 is a diagram of a preferred assembly according to the invention,

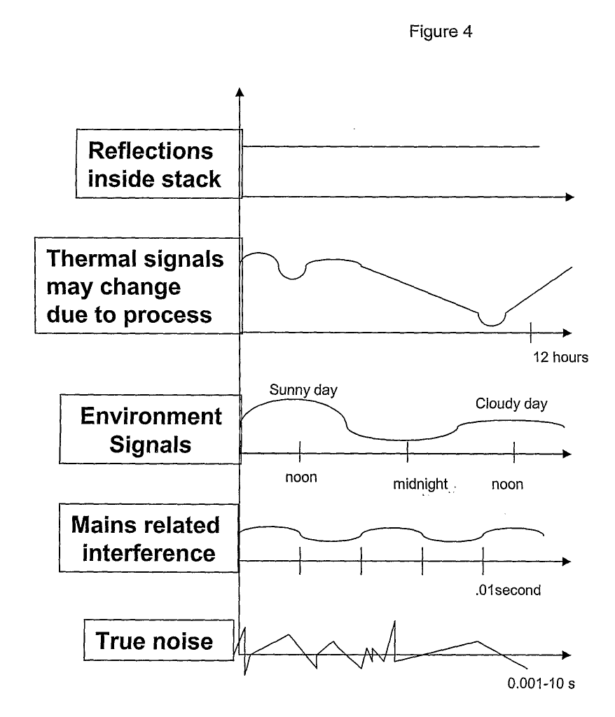

FIG. 4 gives typical graphs of sources that may make up the total signal detected by an instrument mounted on an exhaust or inlet duct,

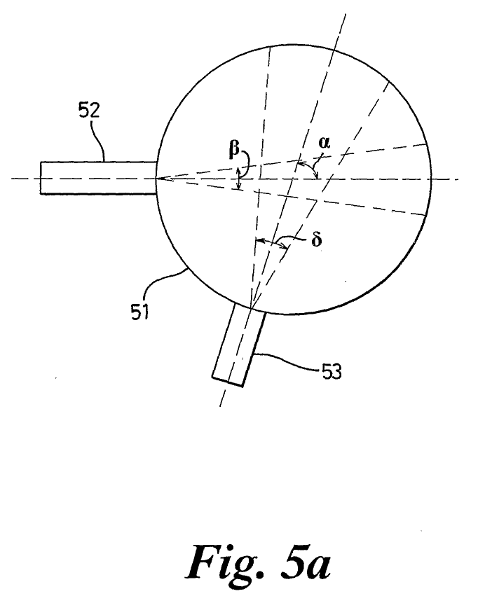

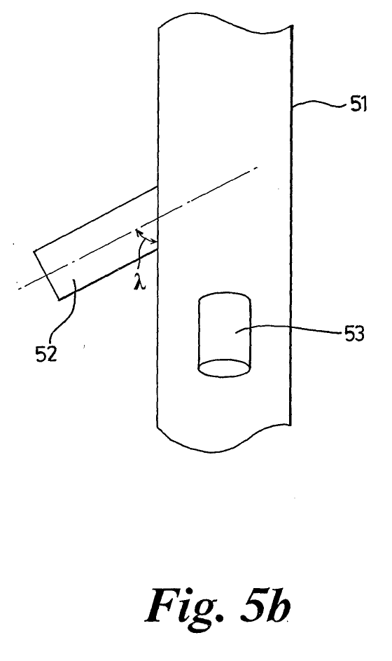

FIG. 5 shows views of location of an emitter and detector when viewed in the direction of fluid flow according to the invention,

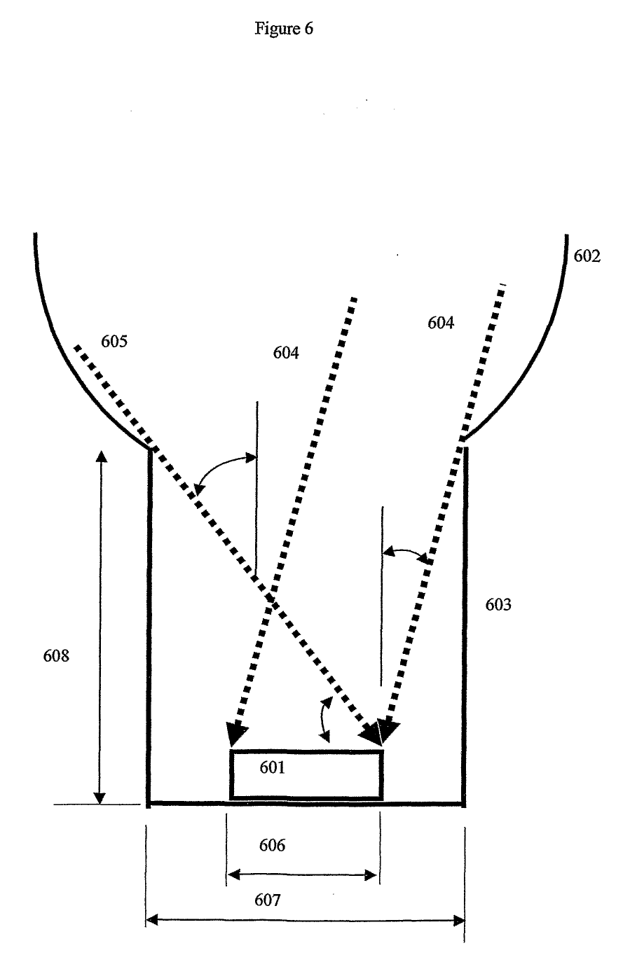

FIG. 6 shows collection geometry and efficiency of a detector,

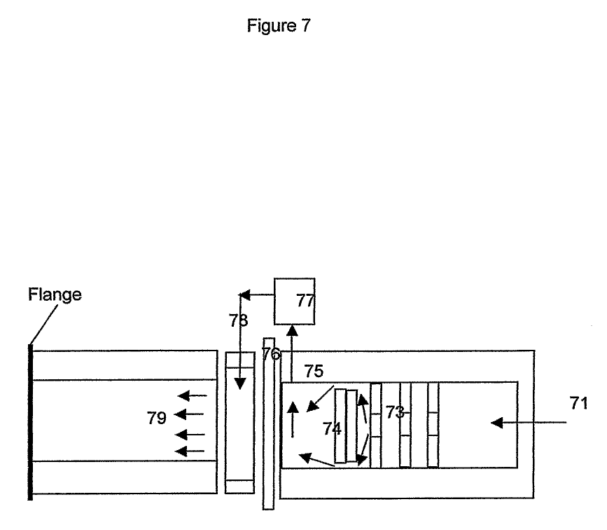

FIG. 7 is a schematic plan of a typical emitter or detector for use in the invention,

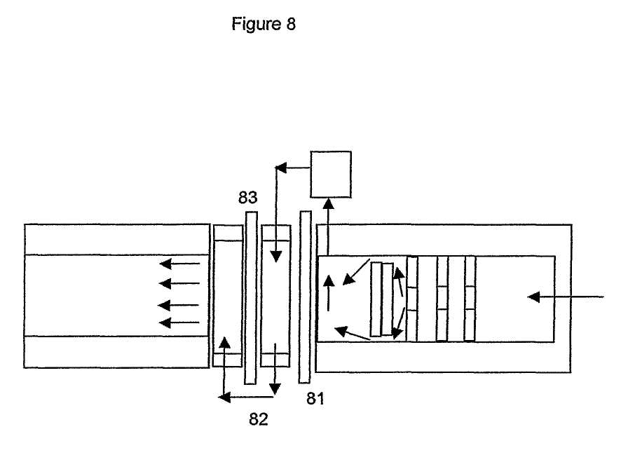

FIG. 8 is a schematic plan of a typical detector for use a high temperatures in the invention,

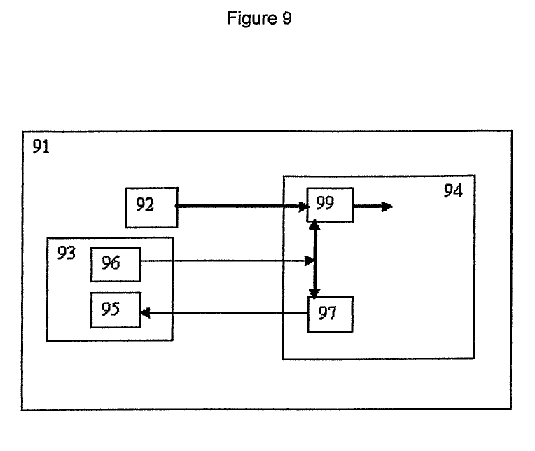

FIG. 9 is a block diagram of an arrangements of circuitry in assemblies according to the invention to provide improved optimum signal to noise ratio,

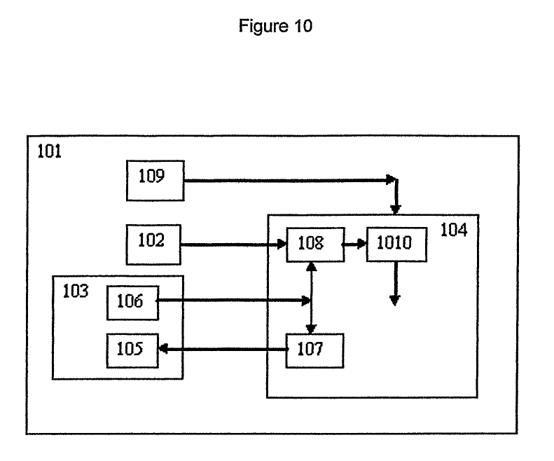

FIG. 10 shows the principle of heartbeat,

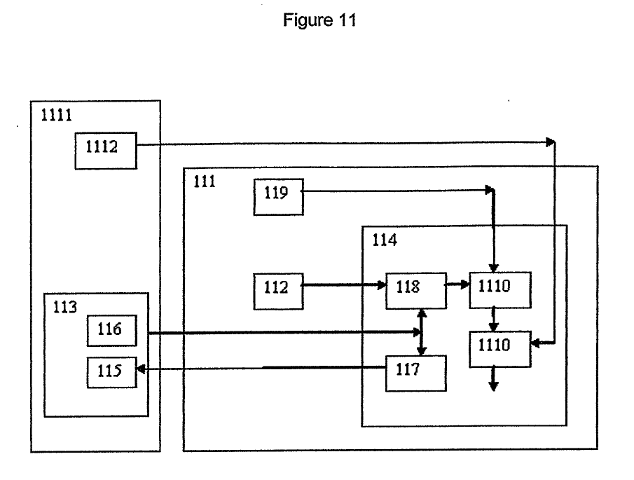

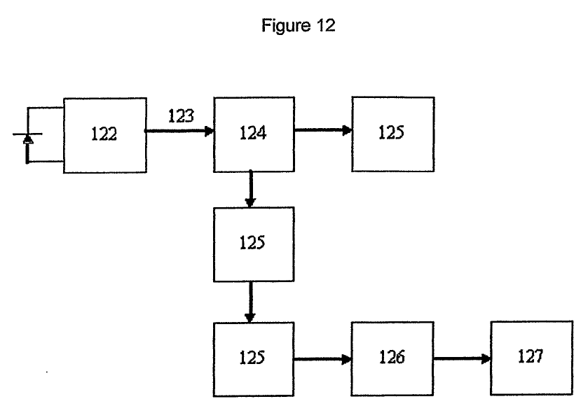

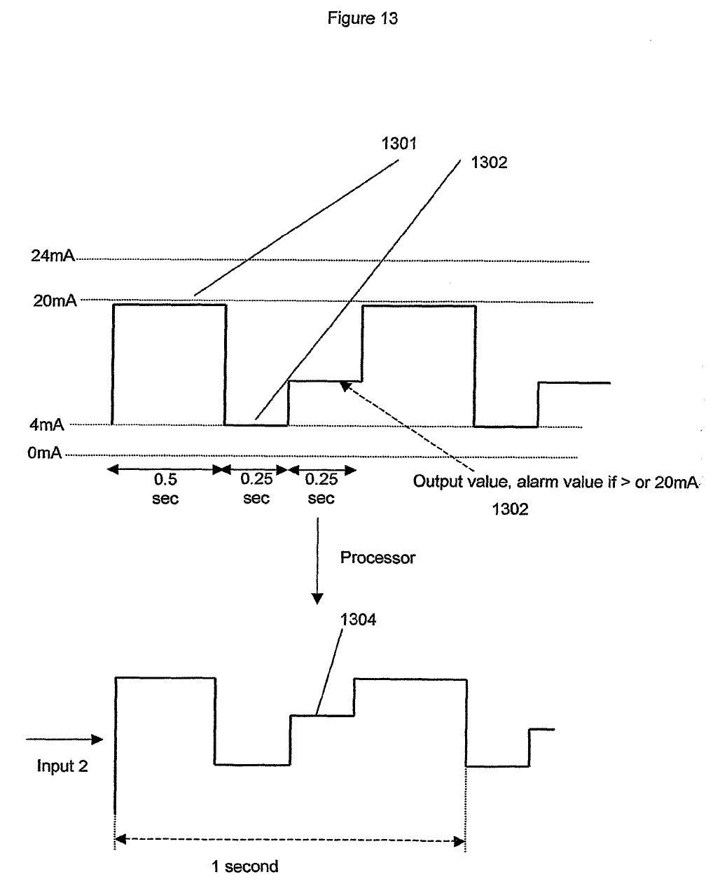

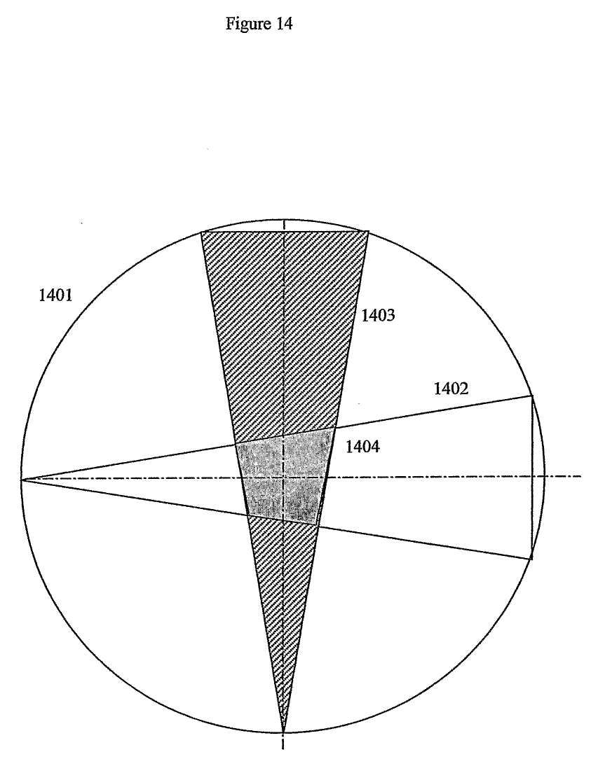

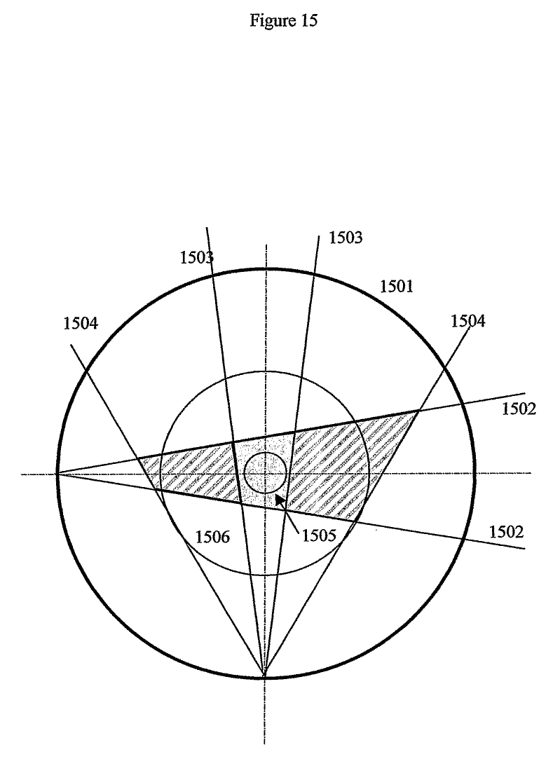

FIG. 11 relates to analysis of particulate to be measured in the duct in accordance with the present invention.

FIG. 1 shows diagrammatically a conventional detection system in which a narrow beam of light (11) is directed into a duct (12), shown in cross section, directly in to a detector (13). Comparison of light intensity emitted from the source and that detected is calculated to give a measure of scattering centre in the duct. Such a method provides data on only a small cross section of the duct and measures both absorption and scatter by impurity. Hence even small absorption by water or substances other than scattering centre can lead to large error in particulate count.

FIG. 2 shows diagrammatically a detection system according to the present invention. A beam of light (21) is directed onto a duct (22) and fanned to give a β_{ey} of 20° and a βₑₓ of 10° and therefore covers about 20% of the cross sectional area of the duct and at its core. A detector (23) is located at 90 to the direction of the light beam, and not directly in the fanned light beam. The detector only detects light scattered by any scattering centre in the duct and there is little or no distortion of the quantity of light detected by absorption.

Whilst in the simple diagram of FIG. 2, a single light source is shown, such as that from, for example, a red light emitting diode, it is possible that a plurality of light sources may be used, for example, red, green and blue sources, so that scatter from each light source may be detected and analysed. Accordingly, absorption can therefore be separated and the interfering agent may be established. In this way, the method and apparatus of the invention can allow spectroscopy.

FIG. 3 is a diagram of a preferred assembly according to the invention. Light from a light emitting diode (LED) (301) rated at 1 W (“Luxeon”, Lumileds), 624 nm is projected pulsewise at 100 pulses per second and a 50% duty cycle controlled by switch (314) through a lens (302), into a duct. Any light scattered by particulate (303) is detected using solar cell (304) (as herein before described), located out of the direction line of the light, and which is protected by a dichoric filter (305), heat mirror (306) and heat shield (307). Protection is required because the duct may be at elevated temperature, e.g. 500° C. Light output intensity from the LED is monitored (308), as is the temperature (309) of the monitor. Output from the monitor (308) is fed to the emitter (301) to stabilise emitter output intensity, and is also fed to collator (310). The LED and its associated electronics, the switch, emitter thermometer and monitor are all housed in the emitter unit. Output from the detector (304) is amplified (312) and is both dc and ac coupled to a collator (310), together with detector temperature information (311). The collator input from the amplifiers is also correlated with pulses from the switch (314). The collator (310) is programmed to measure the light scattered, and correct that measurement for temperature and emitter output variation, and to improve stability of light output from the emitter. The collator, detector, filters, detector thermometer and amplifiers are housed in the figure in the detector unit. Corrected output is then fed to logger (313) for collation and display of scatter information and level of any scattering centre in the duct.

FIG. 4 gives typical graphs of variables that may be experienced by the assembly over various time scales, and which are corrected for in the collator (310) of FIG. 3. These therefore contribute to improvement of temperature stability of the emitter, detector and amplifiers.

FIG. 5 shows views of location of an emitter and detector in the assembly of the invention. FIG. 5a shows a duct (51) viewed in the direction of fluid flow having a circular cross section, an emitter (52) and a detector (53) where the angle (α) between the emitter and the detector is about 70°. Fan angles β of the emitter are β_{ey} of 23° and a βₑₓ of 10°. FIG. 5b shows an emitter which has an elevation angle (λₗ) of 20° when viewed orthogonal to the fluid flow. The detector (53) has a similar elevation angle and fan angles β_{dy}=β_{dx}=30°. With these angles, there is essentially little or no light from the emitter reflected from a wall of the duct to be detected. The arrangement in FIG. 5 results in about 10% of the cross section of the duct being analysed. The present invention does not directly measure absorption which becomes a second or third order error.

The emitter and detector are generally located within respective housing. The housings are attached to a wall of a duct by flanges located on the duct wall and housings. Preferably apertures are provided in the duct wall so that emitter output and scatter detected are not distorted by windows in the apertures.

FIG. 6 relates to collection geometry and efficiency of the detector.

The detector does not usually contain a lens; its numerical aperture (=2×β_{dx} in one direction and =2×β_{dy} in the other direction) is set by the detector housing aperture or the duct flange simply by occlusion of the beam. Typically it is the duct flange.

Whilst the emitter typically has a physical width of, for example, 25 mm, it may be considered a point source having regard to numerical aperture in most duct sizes, the detector is typically of the order of 5 cm and cannot be considered a point source when considering the entire area to be analysed or the weighting of the area.

Where the detection volume is substantially a cone β_{dx}=β_{dy} there are still two differing angles of numerical aperture. The first is the numerical aperture which the entire angle form which the detector can detect radiation and the second is the limiting numerical aperture that defines the edges from which the detector can collect radiation. These are defined in FIG. 6.

A detector (601) is set in a housing and connected to a duct (602) by some form of connector duct (603). The limit of housing window or connector duct diameter will limit the field of view of the detector. In this example, it is the connector duct, and this is typical. Radiation may enter the detector at the maximum clear numerical aperture (604) and at the limiting numerical aperture (605)

FIG. 6 shows the image from above. In cross section, with an elevation angle (Ed), the numerical aperture differs due to different distance from the top of the detector to the duct face than from the bottom of the detector. For first order approximation, it may be simply considered that the ‘average’ numerical apertures are similar to those in plan views.

A typical detector is 50 mm square and so it may be assumed a worst case effective diameter (606) of 50 mm. Limiting optical aperture is the stack duct (607) is typically 76 mm diameter and the approximate distance from the detector face to this limit (608) is approximately 100 mm

This defines a clear numerical aperture of and a limiting numerical aperture of 7 degrees and 32 degrees respectively. Thus radiation is detected with highest efficient over a total included angle of 14 degrees and with reducing efficiency over an angle of 64 degrees. Thus a large portion of the stack is analysed but the measure has some significant weighting to the stack core.

Construction of a typical housing allows the detector to be brought forward without design changes (using differing spacers) approximately 20 mm (in applications where heating from the duct is not excessive) and the standard connector duct length of 76 mm may also be reduced to around 50 mm without significant difficulties in fitting. This increases the limiting numerical aperture to around 45° degrees.

FIG. 7 is a schematic plan of a typical emitter or detector which comprises printed circuit boards (73) appropriate for emitter or detector elements (74). An inlet (71) is provided to allow compressed air to enter the housing and the boards and elements are located so that the air is able to flow around them. The air leaves the housing at (75) adjacent window (76) so ensuring that the window is cooled internally. The air is fed through a one-way valve (77) before being injected across the external face of the window (78), before passing out of the unit and into duct (79) to which the emitter or detector is attached through flanges. Components 71 to 76 and 78 are accommodated within a housing (not shown).

FIG. 8 is a schematic plan of a typical detector, similar to that shown in FIG. 7 (but omitting the flanges and housing) but more appropriate for use at a duct surface temperature of up to 900° C. In FIG. 8, following a first window (81), the air leaves pocket (82) and is fed across a second window (83) before passing out of the unit. The first window is provided with a hot mirror which may operate at a temperature of typically about 400° C.; the second window may be ceramic which is not sensitive to thermal shock and can typically operate up to 900° C.

Filtering of light may occur by three means. The light may be separated according to spectroscopic emission (colour/polarisation etc) or the light may be separated by temporal filtering, such as for example domain analysis, or the light may be separated by means of spatial filtering where physical blocks are used to promote loss of unwanted signals.

In electronics circuits, phase-lock, where the time domain measurement is phase locked with the mains ac frequency, may be used to minimise noise derived from mains electrical supply. In a preferred embodiment of the present invention, spectral, spatial and phase lock are incorporated to provide an optimum signal to noise, and phase lock is further used to ensure that background noise (non-phase locked signals) is within design bounds.

The following FIG. 9 is a block diagram of an arrangements of circuitry in assemblies according to the invention to provide improved optimum signal to noise ratio.

Detector (91) is connected to a DC amplifier (92) in current mode. The use of current mode provides optimum linearity from the detector. The first amplifier (92) is not considered in terms of gain and the gain is fixed as this amplifier is part of the detector circuit. Output voltage signal (93) passes to a DC amplifier of low gain (94). A gain of the order of 10 has been found to be acceptable. The output of this amplifier is split (94); one output is directed to a measurement device (95) which ensures optical baseline (background light) is not such that it has saturated the detectors. The measurement device may include an analogue to digital converter and a processing device.

The other output is passed to an ac amplifier (96) which is phase locked to the mains electrical supply. Light source (not shown) is also phase locked to the mains such that a signal is only present for a quarter of each half mains cycle.

The ac amplifier having programmable gains of between 1 and 50 have been found to be suitable. The ac amplifier is split into blocks such that the gain of each stage is reduced. This appears reduce electrical baselines and saturation problems. The ac amplifier output is measured (96) by an analogue to digital converter (97) and a collator (98). These devices are also phase locked. The data is sent out from the collator to a logger (99). The logger is phase locked to the mains. One means of phaselocking is for the collator to be phaselocked to its power supply and then the logger to be phaselocked to the collator. This ensures that phase errors and skips do not propagate.

The method of phase lock is useful in areas of high radiation as the radiation detected will be a continuous random flux unlike the phase locked signal. In addition, the large size of the detector makes it resistant to small areas of radiation damage. In addition, the nature of the detector (solar cell) makes it resistant to radiation damage. Also, the related nature of the unit makes it protected from the radiation environment and lead shielding/windows may be fitted. In addition, closed loop cooling may be used such that no possibility of release exists.

An additional advantage of the assembly of the invention is that the gain of the system is programmable. The gain of the system may be programmed from the logger position and access to the collator is not required. The use of a collator where at least some parameters may be reprogrammed by a serial link is claimed advantageous

The assembly of the invention is advantageous in that the collator itself contains intelligence such that data sent to the logger is already processed and linearised requiring the logger to carry out fewer functions and thus analyse more data lines.

In industrial situations, the logger may be a significant distance from the collator, frequently of the order of 0.5 km and transmission of data must be robust to noise. Such data transmission may be via a current loop, typically a range of 4-20 mA. A sender controls the voltage to set this current. A current loop has a high noise immunity and is ideally suited for the transmission of analogue signals. However current loops are unsuited to carrying multiple signals. In addition, if a system fails it may generate a signal between 4 and 20 mA continuously, there are no means of checking that the system is behaving correctly. Transmission in such situations may be by digital means. In digital communications, voltage pulses are used to code data and whilst the pulses are not immune to noise, errors may be corrected by data coding or protocols to request resends. However, this type of communication makes significant assumptions of the magnitude and time of the interference and requires a decode means at the emission.

In a preferred embodiment of the assembly of the present invention, data transmission has benefits of both techniques and a further benefits of self-calibration between collator and logger and automatic phase lock between collator and logger. This is defined as heartbeat communications.

A heartbeat is shown in FIG. 10

The heartbeat contains a fixed pattern at the mains frequency (or multiples thereof) which allows the logger to phase lock to this signal. This pattern ensures that should the collator fail and emit a constant current, the logger may easily detect this. The pattern allows error and warning transmitted on a constant current loop (for example, 4-20 mA) whilst the system is operating and this allows multiplexing of data. The pattern allows the maximum and minimum of the collator output to be directed to the logger on each measurement such that calibration between collator and logger is possible. The method ensures the signal integrity of the collator whilst giving multiplexing capacity similar to a digital line. Furthermore, the heartbeat allows a means of “daisy chaining”.

### Daisy Chaining

In many industrial sites, a stack may have multiple assemblies and there may be multiple stacks. The multiplicity of assemblies and stacks require significant cabling requirements where the control room is distant, i,e. location of the logger. This problem of communication is exacerbated where the site is heavy industrial or hot or has spark proof requirements because the fitting of the cabling may be difficult and costly and each new cable increases the risk of cable damage.

The assembly of the present invention allows mitigation these disadvantages by daisy chaining of the collators and heartbeat signals.

The present assembly may process data as hereinbefore described and output data at a rate of 1 to 0.01 Hz. This data may be passed not directly to a logger but to the next nearest collator. The collator, having internal processing, may combine this signal with its own derived data and transmit the signal to the next collator and so on. In such a means a single cable passes to the control room containing the logger from a number of collators. This procedure allows significant cost reduction and a route to increasing quality/integrity of the single cable without cost increase. Additionally, the present system has both a serial link and a set of analogue to digital converters and it is claimed it may be programmed to detect signals from other instruments and thus the present system may itself provide a multiplexed transmission means.

In addition the method allows a means of common phaselock over numerous systems. Heartbeat is defined as the signal equivalent to a quantity of scattered radiation that would generate a full scale reading (1001) followed by the minimum signal (1002) followed by the actual value (1003). This signal is repeated at the same sample output rate of the head which is typically 1 Hz which is a function of the phase lock of the mains. The logger unit phase locked to the mains signal may thus detect and correctly log the signal. Where daisy chaining of instruments occurs, the signal may be transmitted to a second assembly where the signal is detected and repackaged with the second output (1004) over the same timescale. This emission may similarly be sent to a third system where the signal is again detected and repacked with its own signal. This may continue. As the collators have processing capability and may carry out averaging, peak detect and other processing, this reduces the data transmission such that multiple signal systems may fit on a single loop.

FIG. 11 relates to analysis of particulate to be measured in the duct in accordance with the present invention.

One way is to measure the volume of the duct that first order scatter may be detected. This is a measure of total volume and is a function of the angle λ_{d}. Increase in λ_{d} increases the total scattering volume. However it is stated that, provided this volume is large enough to ensure ensemble averaging (that over 100 particles are detected in the scattering volume per sample period for 1% accuracy), increase of the scattering volume is not a significant benefit.

Better detection is to consider the cross sectional area of the duct, defined when the duct is viewed orthogonally to fluid flow. This is independent of the elevation angle(λ_{d}). This detection method may be more significant because, if the cross section is very small, any slight variation in the dust density profile across the duct will give rise to an apparent change in dust level, even where ensemble averaging has occurred.

FIG. 11 shows an approximation of the scattering cross section orthogonal to fluid flow for 90° scatter. In FIG. 11 the detector and emitter are shown to be point sources which will be approximate for ducts much larger than the detector but in all cases this underestimates the actual cross sectional area of the duct analysed.

The duct (1101) has an emitter sending a fan of light across the duct (1102) which intercepts the fan that defines the numerical apertures of the detector (1103). First order scattering will be detected only from the area of the intersection (1104) although second and high order scattering can be detected from anywhere in the numerical aperture of the detector (1103)

If aerodynamic focusing is insignificant, particulate density across the duct will be uniform but the flow rates are not; hence measuring the centre of the stack ensure a greater percentage of the total emitted scattering particulates are measured than if measuring near the wall. Measuring the core area, as occurs with this invention, is a more robust average than any means that measures near the walls.

1: An assembly which comprises
(a) a duct for transmission of fluids, said duct having longitudinal axis,
(b) at least one emitter capable of exciting a beam of radiation in the form of a cone having root angles βₑₓ and β_{ey}, which may be the same or different, into a cross section area of a duct to be analyzed in a direction downstream of fluid flow in the duct at an angle λₑ from the plane perpendicular to the longitudinal axis of the duct, the angle λₑ being between 5° to 45°,
(c) a detector sensitive to radiation radiated by scattering centers in the fluid over at least 1% of the cross sectional area of the duct, the direction of the central axis of the emitter cone being at an angle α to the direction of the central axis of the detector cone, the detector cone having root angles β_{dx} and β_{dy}, which may be the same or different and the detector cone having angle λ_{d} perpendicular to the longitudinal axis of the duct, the direction of the detector being downstream of fluid flow in the duct, the angle α being in the range 0° to 180° and angle λ_{d} being between 5° to 45°, the detector collecting scattered radiation and the detector being coupled to
(d) a collator for collecting data from the detector.

2: An assembly as claimed in claim 1, in which the detector is ac coupled to the collator.

3: An assembly as claimed in claim 1, in which the collator is configured to correct for any errors or variations in the data caused by transient factors.

4: An assembly according to claim 1, in which the assembly further comprises:
(a) a logger for processing the signal from the collator and comparing its level to known contamination level and providing information on the detected radiation.

5: An assembly as claimed in claim 1 in which β_{ey}>βₑₓ.

6: An assembly as claimed in claim 1 in which β_{dx}=β_{dy}.

7: An assembly as claimed in claim 1 in which α is between 60° and 85°.

8: An assembly as claimed in claim 1 in which λₑ is between 10° and 20°.

9: An assembly as claimed in claim 1 in which λ_{d} is between 10° and 20°.

10: An assembly as claimed in claim 1 in which the emitter and detector are effective only on an area of the core of the duct.

11: An assembly as claimed in claim 1 in which the emitter is housed within a unit which comprises the emitter and associated electronics.

12: An assembly as claimed in claim 1 in which the detector is housed within a unit which comprises the detector and associated electronics.

13: An assembly as claimed in claim 12 in which the detector unit also contains the collator.

14: An assembly as claimed in claim 13 in which the units also contain filters.

15: An assembly as claimed in claim 14 in which at least one of the units is provided a source of gas to maintain the contents of the units at a desired temperature.

16: An assembly as claimed in claim 1 in which the emitter is a light emitting diode.

17: An assembly as claimed in claim 16 in which the light emitting diode has a spectrum in the range 610 to 640 nm.

18: A method for monitoring impurity in fluid within a duct having a longitudinal axis which comprises
(a) exciting a beam of radiation from an emitter in the form of a cone having root angles βₑₓ and β_{ey}, which may be the same or different, into a cross section area of a duct to be analyzed in a direction downstream of fluid flow in the duct at an angle λₑ perpendicular to the longitudinal axis of the duct, the angle λₑ being between 5° and 45°,
(b) detecting radiation radiated by any scattering center in the fluid over at least 1% of the cross sectional area of the duct, the direction of the central axis of the detector cone, the detector having root angles β_{dx} and β_{dy}, which may be the same or different, in the range 10° to 40° and the detector cone having an angle λ_{d} from the plane perpendicular to the longitudinal axis of the duct, the direction of the detector being downstream of fluid flow in the duct, the angle α being in the range 0° to 180° and angle λ_{d} being between 5° to 45°,
(c) orientating the detector in a position on the duct that is not directly in the light beam, and
collating data from the detector whereby interaction of the light is detected and at least one parameter of any scattering center in the fluid is measured.

19: A detector unit which comprises a housing for attaching the unit to a duct and for accommodating detector components, said components comprising a detector and electronic circuit boards for receiving signals from the detector, and inlets and outlets for gas for circulation around the detector components.

20: An emitter unit which comprises a housing for attaching the unit to a duct and for accommodating emitter components, said components comprising an emitter and electronic circuit boards for stimulating signals to be emitted from the emitter, and inlets and outlets for gas for circulation around the emitter components.

21: A unit as claimed in claim 20 in which at least one window is provided to shield the components from thermal and/or heat shock.

22: A unit as claimed in claim 21 in which the outlet for the gas is provided with a one way valve the outlet is adapted to feed air around the window without a possibility of said air entering the area of the duct containing the components.
